(19) United States
(12) Patent Application Publication
(10) Pub. No.: US 2002/0184147 A1
(43) Pub. Date: Dec. 5, 2002

(54) System for paying invoices

(76) Inventor: Gordon D. Boulger, Green Oaks, IL (US)

Correspondence Address: BUCKLEY, MASCHOFF, TALWALKAR, & ALLISON, 5 ELM STREET, NEW CANAAN, CT, 06840, US

(21) Appl. No.: 09/874,150

(22) Filed: Jun. 5, 2001

(51) Int. Cl. G06F 17/60

(52) U.S. Cl. 705/40

(57) ABSTRACT

A system to pay an invoice includes reception of a code and a payable amount associated with an expense, identification of a user associated with the code, presentation of the expense to the user, reception of an instruction to pay the payable amount, and determination of whether the payable amount is less than or equal to an approved amount associated with the code. By using a code associated with an appropriate user, an expense may be easily directed to a user authorized to evaluate and instruct payment of the expense.

### BACKGROUND OF THE INVENTION

1. Field of the Invention

The present invention relates to electronic payment systems. In one aspect, the present invention relates to systems for providing authorized payment of invoiced expenses.

2. Discussion of the Prior Art

Electronic systems are commonly used to facilitate bill payment. For example, many banks allow customers to pay bills electronically using telephones, dedicated terminals, and the World Wide Web. Typically, a customer accesses such a bank-provided system and is presented with a payable amount. The customer inputs a command to pay the amount and, in response, the bank pays the amount and deducts the amount from an appropriate account of the customer.

The foregoing system is not suitable for payee businesses. Specifically, the system does not allow particular employees to authorize payment of particular business expenses. Instead, the system allows a single authorized person to authorize payment of all payable amounts.

As an additional drawback, the system automatically pays a payable amount after receiving authorization to pay the payable amount. Businesses cannot afford to relinquish control of the timing of payments to authorizing employees. In this regard, most businesses require employees to pass payment authorizations to an accounting department. The accounting department then issues payments in accordance with the authorizations and in view of budgeting considerations such as account balances, real and anticipated expenses, payment deadlines and vendor agreements. This process allows businesses to manage their finances in an appropriate manner. However, insertion of the accounting department in the payment process causes delay in payment.

In an attempt to address the shortcomings of customer-business payment systems, electronic payment systems have been developed especially for use by businesses. According to one such system, an employee defines a purchase order including details such as item, amount, price, and vendor. Once an invoice is received, the invoice is compared against a database of defined purchase orders to determine if the invoice corresponds to a defined purchase order. If so, the invoice is paid. If not, the invoice is subjected to traditional processing.

The system must ensure that the received invoice corresponds exactly to a defined purchase order so that unapproved invoices are not automatically paid. In order to achieve this high level of certainty, many details of the purchase order must be included in the definition of the purchase order, and each of these details must match exactly with details of the invoice to ensure that the invoice corresponds to the purchase order. Under such strict scrutiny, however, many received invoices are determined not to correspond to any defined purchase orders even if the received invoices do in fact correspond to a defined purchase order. This discrepancy may be caused by many factors, including vendor error in creating an invoice that corresponds perfectly to a defined purchase order.

In view of the foregoing, what is needed is a system to pay invoices that provides prompt, efficient and accurate payment.

### BRIEF SUMMARY OF THE INVENTION

In order to address this need, the present invention concerns a system to pay an invoice including reception of a code and a payable amount associated with an expense, identification of a user associated with the code, presentation of the expense to the user, reception of an instruction to pay the payable amount, and determination of whether the payable amount is less than or equal to an approved amount associated with the code. In some embodiments, the foregoing features allow prompt payment of payable amounts because the payable amounts are preapproved. Moreover, by using a code associated with an appropriate user, an expense may be easily directed to a user authorized to evaluate and instruct payment of the expense. As a result, the foregoing features provide a combination of prompt, accurate and authorized payment that is unavailable using prior systems.

In another aspect, the present invention relates to a system to pay an invoice in which a code and a payable amount associated with an expense are received, it is determined if the payable amount is less than or equal to an approved amount associated with the code, and the expense is presented to a user associated with the code if it is determined that the payable amount is less than or equal to the approved amount. Since presentation of an expense to an authorized user is based on whether a payable amount associated with the expense has been approved, this aspect reduces a likelihood that a nonapproved payable amount will be paid.

In yet another aspect, the present invention concerns a method for paying an invoice including reception of a code and a payable amount associated with an expense, determination of whether the payable amount is less than or equal to an approved amount associated with the code, and transmission of an indication to a user associated with the code if it is determined that the payable amount is not less than or equal to the approved amount. According to this aspect, the indication indicates that the payable amount is not less than or equal to the approved amount. By virtue of the features of this aspect, a user authorized to instruct payment of a payable amount may be notified when the payable amount is greater than an associated approved amount.

The present invention also relates to a system in which a code and a payable amount associated with an expense are received, a user associated with the code is identified, an approved amount associated with the code is identified, and the expense, the payable amount, and the approved amount are presented to the user. As a result, this aspect allows proper routing of an expense to a user authorized to instruct payment of the expense, and provides the user with information for determining whether or not to instruct payment of the payable amount.

It should be noted that, in addition to the particular benefits mentioned with respect to the previous three aspects of the invention, these aspects also provide prompt, accurate and authorized payment by virtue of at least their provision of associated codes, users and approved amounts.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to pay an expense according to embodiments of the invention.

FIG. 2 is a diagram of a system architecture according to embodiments of the invention.

FIG. 3 is a block diagram of a software and data flow architecture according to embodiments of the invention.

FIG. 4 is a block diagram illustrating an internal architecture of a payment server according to embodiments of the present invention.

FIG. 5 is a block diagram illustrating an internal architecture of a vendor device according to embodiments of the present invention.

FIG. 6 is a block diagram illustrating an internal architecture of a client device according to embodiments of the present invention.

FIG. 7 is a tabular representation of a portion of a virtual bank account database according to embodiments of the present invention.

FIG. 8 is a tabular representation of a portion of an invoice database according to embodiments of the present invention.

FIGS. 9A and 9B illustrate a flow diagram of process steps to pay an invoice according to embodiments of the invention.

FIG. 10 is an outward view of a user interface presenting expenses according to embodiments of the invention.

FIG. 11 is an outward view of a user interface presenting a detailed expense according to embodiments of the invention.

FIG. 12 is an outward view of a user interface presenting information according to embodiments of the invention.

FIG. 13 is a tabular representation of a portion of a virtual bank account database according to embodiments of the present invention.

### DETAILED DESCRIPTION OF THE INVENTION

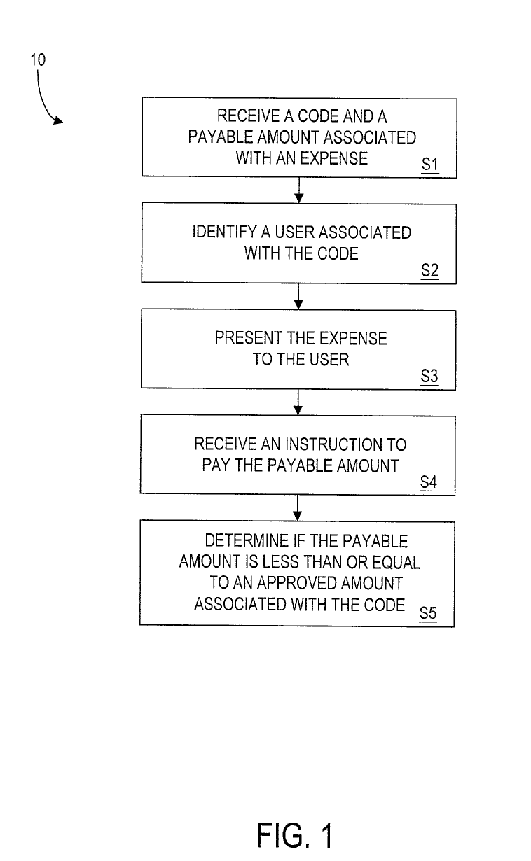

FIG. 1 is a flow diagram of process steps 10 to pay an invoice according to embodiments of the present invention. In order to provide an immediate introduction to features of the present invention, process steps 10 will now be described without details of a particular embodiment. Of course, a complete description of specific hardware and software embodiments of the claimed invention is set forth below.

Process steps 10 begin at step S1, in which a code and a payable amount associated with an expense are received. As used herein, an expense may include materials, labor, services, a particular project or task, a vendor, or any other classification under which a payable amount may be due. Accordingly, a code associated with an expense may also represent any of these classifications. The code and the payable amount may be received from a vendor in the form of an invoice setting forth several expenses. In one example, a vendor sends the invoice in electronic format to a payment server, and the invoice is received in step S1.

In step S2, a user associated with the received code is identified. According to some embodiments, each of a plurality of users is associated with one of a plurality of codes in a data structure. Therefore, in step S2, the received code is located in the data structure and a user associated with the received code in the data structure is identified. The received expense is then presented to the user in step S3.

The expense may be presented to the user by electronically transmitting an invoice including the expense to a device operated by the identified user. In a specific example of step S3 to be described in more detail below, the identified user is sent an electronic mail message including a hyperlink. The user views the message by using a client device to access his electronic mail account. After the user selects the hyperlink, a Web page including a representation of the received expense and the payable amount associated with the expense is transmitted from a Web server to the client device. Of course, other systems may be used in step S3 to present the expense to the user.

An instruction to pay the payable amount is received in step S4. Continuing with the above specific example, the Web page presented to the user may include an icon selectable by the user to issue an instruction to pay the payable amount. Accordingly, the Web server receives the instruction in step S4.

Next, in step S5, it is determined whether the payable amount is less than or equal to an approved amount associated with the code. The approved amount may be an amount also associated with the code in the data structure described above. In some embodiments, the approved amount reflects an amount for which spending approval has been received from an accounting department of a client business. Accordingly, if it is determined in step S5 that the payable amount is less than or equal to an approved amount associated with the code, a command may be issued to pay the payable amount. As described above, process steps 10 advantageously allow prompt, accurate and authorized payment of amounts payable by business entities.

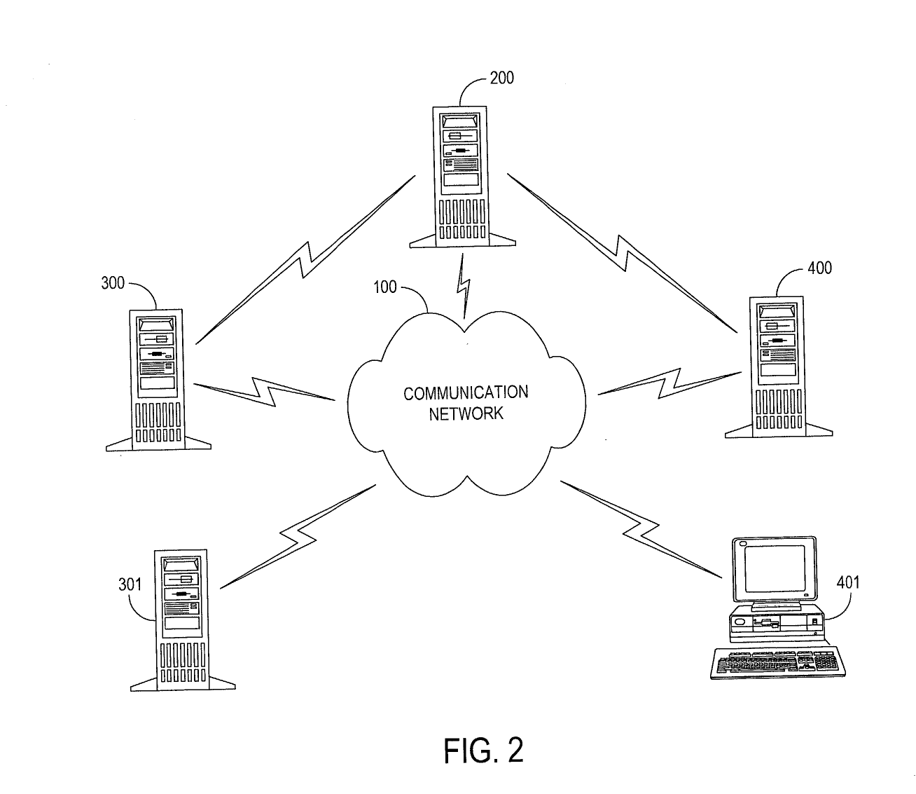

FIG. 2 shows communication network 100 in communication with payment server 200, vendor devices 300 and 301, and client devices 400 and 401. Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Moreover, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

Payment server 200 may comprise a network server or other device capable of performing the functions described herein. Payment server 200 may provide payment services for one or more client businesses, such as invoice reception, invoice delivery, invoice storage, invoice tracking, payment using automated clearing house feeds, check writing or the like, account balancing, and transaction reporting. According to one embodiment, payment server 200 operates to receive a code and a payable amount associated with an expense, to identify a user associated with the code, to present the expense to the user, to receive an instruction to pay the payable amount, and to determine whether the payable amount is less than or equal to an approved amount associated with the code.

Vendor devices 300 and 301 may also comprise a network server or other computing device. Each of vendor devices 300 and 301 may provide billing functions for one or more vendor businesses. Of course, each of vendor devices 300 and 301 may provide other functions such as accounting, inventory tracking and the like. Similarly, client devices 400 and 401 comprise a network server and a workstation, respectively, for providing functionality to one or more client businesses. In this regard, client device 401 may be used by an employee to create virtual bank accounts, to access electronic mail, and to instruct payment of expenses, while client device 400 may be used to track inventory, to perform accounting functions and to provide network services for the client business.

In other embodiments, the devices of FIG. 2 are connected differently than as shown. For example, some or all of the devices may be connected directly to one another. Of course, embodiments of the invention may include devices that are different from those shown.

It should also be noted that although the devices are shown in communication with each other, the devices need not be constantly exchanging data. Rather, communication may be established when necessary and severed at other times or always available but rarely used to transmit data. Moreover, although the illustrated communication links between the devices of FIG. 2 appear dedicated, it should be noted that each of the links may be shared by other devices.

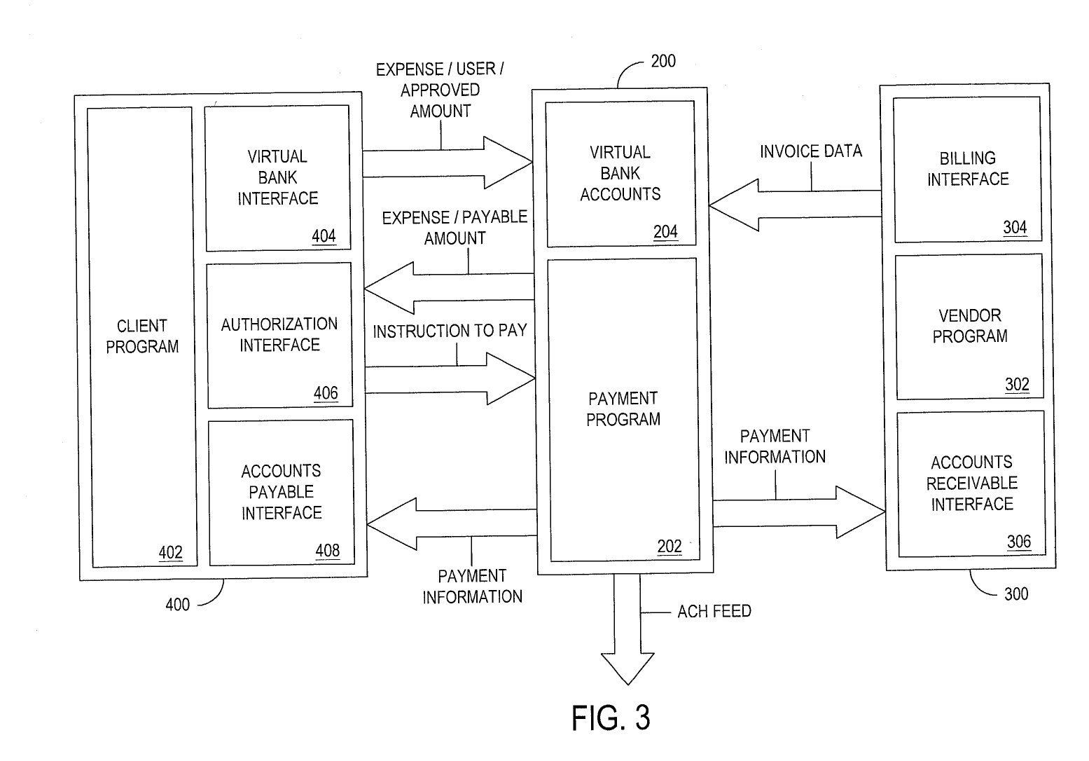

FIG. 3 is a functional block diagram of a software and data flow architecture according to embodiments of the present invention. Shown in FIG. 3 are block representations of payment server 200, vendor device 300 and client device 400, each including components used to embody the present invention.

As shown, payment system 200 includes payment program 202 and virtual bank accounts 204. Payment program 202 comprises processor-executable process steps executed by payment server 200 in order to operate in accordance with the present invention. Generally, the process steps of payment program 202 provide reception of a code and a payable amount associated with an expense from vendor device 300, identification of a user associated with the code in virtual bank accounts 204, presentation of the expense to the user by transmission of the expense to client device 400, reception of an instruction to pay the payable amount from client device 400, and determination of whether the payable amount is less than or equal to an approved amount associated with the code in virtual bank accounts 204. In some aspects, the foregoing features allow prompt payment of payable amounts because the payable amounts are preapproved. In this regard, payment program 202 may execute payment via an Automated Clearing House (ACH) feed to a bank or other institution or directly to vendor device 300 using cash or an electronic form of payment.

Virtual bank accounts 204 include information used to match received expenses with approved amounts and users authorized to instruct payment. In this regard, information stored in virtual bank accounts 204 may associate a code, an expense, an approved amount, and a user or users authorized to instruct payment of a payable amount associated with the expense.

Accordingly, payment program 202 may be used in conjunction with the information stored in virtual bank accounts 204 to associate a payable amount and code received from a vendor device with an authorized user and an approved amount. As a result, the authorized user may be presented with the payable amount and, if the user instructs payment of the payable amount and the payable amount is less than the approved amount, the payable amount may be paid quickly.

In the illustrated embodiment, the payable amount and the code are received from vendor device 300 using vendor program 302 and billing interface 304. For example, processor-executable process steps of vendor program 302 are executed by vendor device 300 to create an invoice including at least one expense, an associated payable amount and an associated code. Billing interface 304 then converts the invoice to electronic invoice data such as a print stream, ANSI X12, XML or an HTML page that can be interpreted by payment program 202 of payment server 200.

Process steps of vendor program 302 may also be used to perform other billing functions, accounting functions, inventory functions and any other functions required by a vendor operating vendor device 300. In this regard, vendor device 300 also includes accounts receivable interface 306 through which payment and payment information may be received from payment server 200. Accordingly, vendor program 302 may also be used to ensure that the payment is deposited in an appropriate account of the vendor and to update the vendor's accounts receivable information based on the received payment information.

Client device 400 includes client program 402 and several software interfaces. In addition to including process steps executable to provide functionality in accordance with the present invention, client program 402 may provide any other function desired by a client business operating client device 400, such as Web access, payroll, inventory, network monitoring, and intranet messaging. Virtual bank interface 404 is used in conjunction with process steps of client program 402 to transmit data to payment server 200 for storage in virtual bank accounts 204. More specifically, a client operates client program 402 to input an expense, an approved amount and an authorized user. The input information is then transmitted to payment server 200 via virtual bank interface 404. Payment program 202 is executed to receive the information and to store the information in association with a code in virtual bank accounts 204. It should be noted that the associated code may also be input by the client or generated by client program 402 and transmitted to payment server 200.

Authorization interface 406 is used in conjunction with client program 402 to receive invoice information such as an expense and an associated amount and to present the information to an authorized user. Authorization interface 406 is also used to transmit an instruction to pay the payable amount to payment server 200. After the instruction is transmitted, accounts payable interface 408 receives information confirming the payment and providing details of the payment. Client program 402 operates in conjunction with accounts payable interface 408 to update accounting information maintained by client device 400 based on the received payment information.

The following is a brief description of the operation of the FIG. 3 architecture according to some embodiments of the invention. Of course, the invention is not to be deemed limited by particular features set forth in the description. Initially, an operator of client device 400 inputs a command instructing client program 402 to create a virtual bank account. The operator also inputs an expense, an authorized user and an approved amount to associate with the virtual bank account. Input and reception of the associated information may be controlled by one or both of client program 402 and virtual bank interface 404. As shown, the expense, authorized user and approved amount are transmitted to payment server 200 from virtual bank interface 404 and are associated together with a code to create a virtual bank account within virtual bank accounts 204. As described above, the virtual bank account facilitates pre-approval of amounts associated with expenses and provides an efficient system for identifying expenses and authorizing payment of the associated amounts.

An invoice is then prepared by vendor program 302, alone or in conjunction with billing interface 304. The invoice may represent materials and/or services provided to a client operating client device 400. Included in the invoice are a description of an expense, a payable amount and a code associated with the expense and the payable amount. In one embodiment, the client has previously instructed the vendor to associate the code with the expense on any invoice concerning the expense. Of course, the invoice may include several codes associated with other expenses and payable amounts.

The invoice is transmitted from vendor device 300 to payment server 200. In some embodiments, the invoice is transmitted in a print stream format. Such an arrangement facilitates incorporation of vendor device 300 into a system embodying the invention in a case that vendor device 300 was previously used to output invoices in hardcopy format. Of course, an invoice may be transmitted to payment server 200 in any format readable by payment server 200, including HTML, ANSI x12, XML, ASCII, and hardcopy text.

After the invoice is received, payment server 200 executes payment program 202 to identify a code included in the invoice and also identifies a user associated with the code in virtual bank accounts 204. Payment server 200 then transmits an electronic mail message including a hyperlink to the user. Next, the user accesses his electronic mail using client device 400 and is presented with the message. The message may indicate that an invoice has been received requiring the user's authorization, and that the hyperlink allows the user to view and approve of the invoice.

After the user selects the hyperlink, authorization interface 406 transmits to payment server 200 a request to receive invoice information associated with the hyperlink. Accordingly, payment server 200 transmits the expense and the payable amount to authorization interface 406. The received expense and the payable amount are presented to the user using client program 402. Also presented to the user may be an approved amount that is associated with the received code in virtual bank accounts 204. Although this embodiment contemplates that elements of authorization interface 406 and client program 402 comprise a Web browser, other systems for transferring information between payment server 200 and client device 400 may be employed.

The user operates client device 400 to issue an instruction to pay the received payable amount. As shown, the instruction may be transmitted by authorization interface 406 to payment server 200. After the instruction is received, payment server 200 determines whether the payable amount is less than or equal to the approved amount that is associated in virtual bank accounts 204 with the code received from vendor device 300. If so, payment program 202 is executed to pay the payable amount to the vendor, using a direct feed to an Automated Clearing House, and provides details of the payment to accounts receivable interface 306. Alternatively, the payment may be transmitted to accounts receivable interface 306 in electronic, cash, or check form. In either case, accounts receivable interface 306 is used to update accounting records stored in vendor device 300 based on the received payment. It should be noted that, in some embodiments, the payable amount is paid to the vendor in response to the received instruction and without determining whether the payable amount is less than or equal to the approved amount.

Payment server 200 also transmits payment information to accounts payable interface 408 of client device 400. The payment information may include details of the payment to the vendor such as a payment date, a check/transaction number, means of payment, and a confirmation number. Accounts payable interface 408 operates in conjunction with client program 402 or an accounting application to update client accounts and records based on the received payment information.

Of course, many variations of the foregoing system are possible. For example, one or more client devices may be used to perform each of the functions of creating a virtual bank account, receiving an expense and associated payable amount, transmitting an instruction to pay a payable amount, and receiving payment information. Specifically, a workstation operated by a purchasing department of a client may transmit virtual bank account information to create a virtual bank account, a workstation operated by a manager may receive expense information and transmit an instruction to pay a payable amount, and an accounting server may receive the payment information. Similarly, one or more devices may be used to perform the functions attributed above to payment server 200 and to vendor device 300.

In other embodiments, one or more of virtual bank accounts 204 specifies more than one authorized user. According to these embodiments, electronic mail messages are transmitted to each authorized user associated with an expense, and any of the authorized users may instruct payment of the expense. Alternatively, payment may be issued only after receiving instructions from all the authorized users.

In still other embodiments, an expense and an associated payable amount are transmitted to an associated user only if the payable amount is less than or equal to an associated approved amount. Alternatively, if the payable amount is greater than an associated approved amount, the expense and payable amount are transmitted to client device 400 along with an indication that the payable amount is greater than the associated approved amount.

As can be gleaned from the foregoing, a system embodying the present invention provides prompt, efficient and authorized payment of expenses. Particularly, a virtual bank account including an associated code, approved amount and authorized user allows pre-approval of expenses as well as automatic identification and routing of received expenses for approval. As a result, a system according to the present invention may provide a balance of pre-approval, automatic routing and human intervention that is more advantageous than that provided by prior systems.

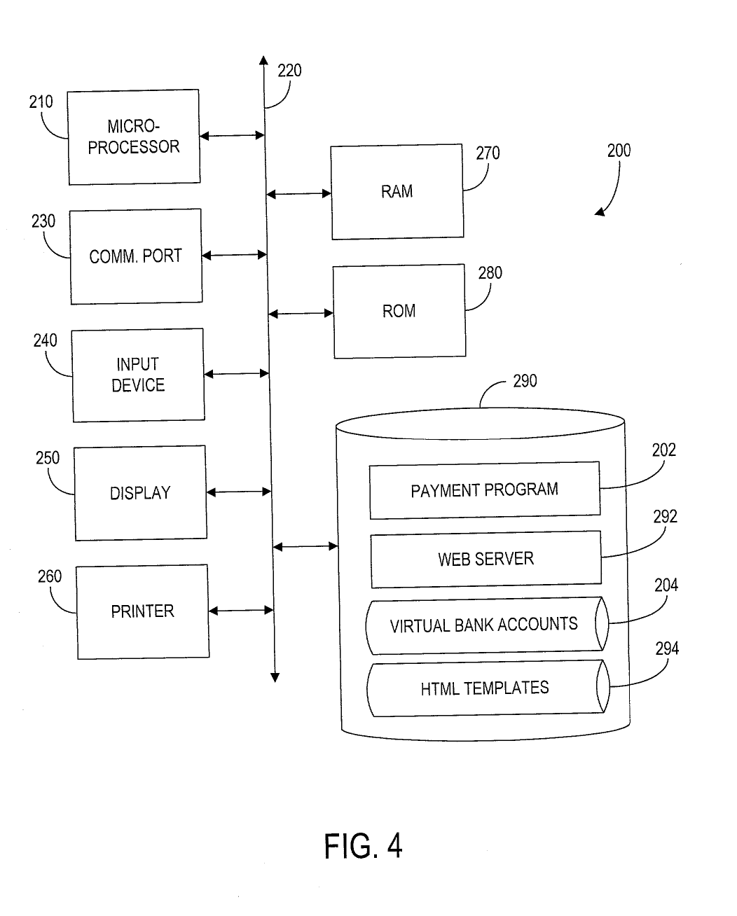

FIG. 4 is a block diagram of the internal architecture of payment server 200 according to embodiments of the invention. As illustrated, server 200 includes microprocessor 210 in communication with communication bus 220. Microprocessor 210 may be a Pentium, RISC-based, or other type of processor and is used to execute processor-executable process steps so as to control the elements of server 200 to provide desired functionality.

Also in communication with communication bus 220 is communication port 230. Communication port 230 is used to transmit data to and to receive data from devices external to payment server 200. Communication port 230 is therefore preferably configured with hardware suitable to physically interface with desired external devices and/or network connections. For example, communication port 230 may comprise an Ethernet connection to a network through which payment server 200 may receive and transmit information over the Web.

Input device 240, display 250 and printer 260 are also in communication with communication bus 220. Any known input device may be used as input device 240, including a keyboard, mouse, touch pad, voice-recognition system, or any combination of these devices. Input device 240 may be used by a client entity to input virtual bank account information, user passwords, instructions to pay a payable amount, and other information to payment server 200. Of course, such information may also be input to payment server 200 via communication port 230.

Information may be presented to a user via display 250, which may be an integral or separate CRT display, flat-panel display or the like, in response to commands issued by microprocessor 210. Information may include an electronic message, HTML pages, or other text and graphics. Printer 260 may also present text and graphics to a user, but in hardcopy form using inkjet, thermal, dot-matrix, laser, or other printing technologies. Printer 260, as well as display 250, may also be used to output accounting information such as accounts payable and virtual bank account information.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, processor-executable process steps of payment program 202. Microprocessor 210 executes the process steps of payment program 202 in order to control payment server 200 to pay an invoice in accordance with the present invention. More specifically, the process steps of payment program 202 may be executed by microprocessor 210 to receive a code and a payable amount associated with an expense, to identify a user associated with the code, to present the expense to the user, to receive an instruction to pay the payable amount, and to determine whether the payable amount is less than or equal to an approved amount associated with the code.

The process steps of payment program 202 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Data storage device 290 also stores processor-executable process steps of World Wide Web (“Web”) server 292. The process steps may be executed by microprocessor 210 to transmit data to and receive data from Web clients, such as Web browsers, over the Web. The data may include HTML pages representing expenses and associated payable amounts.

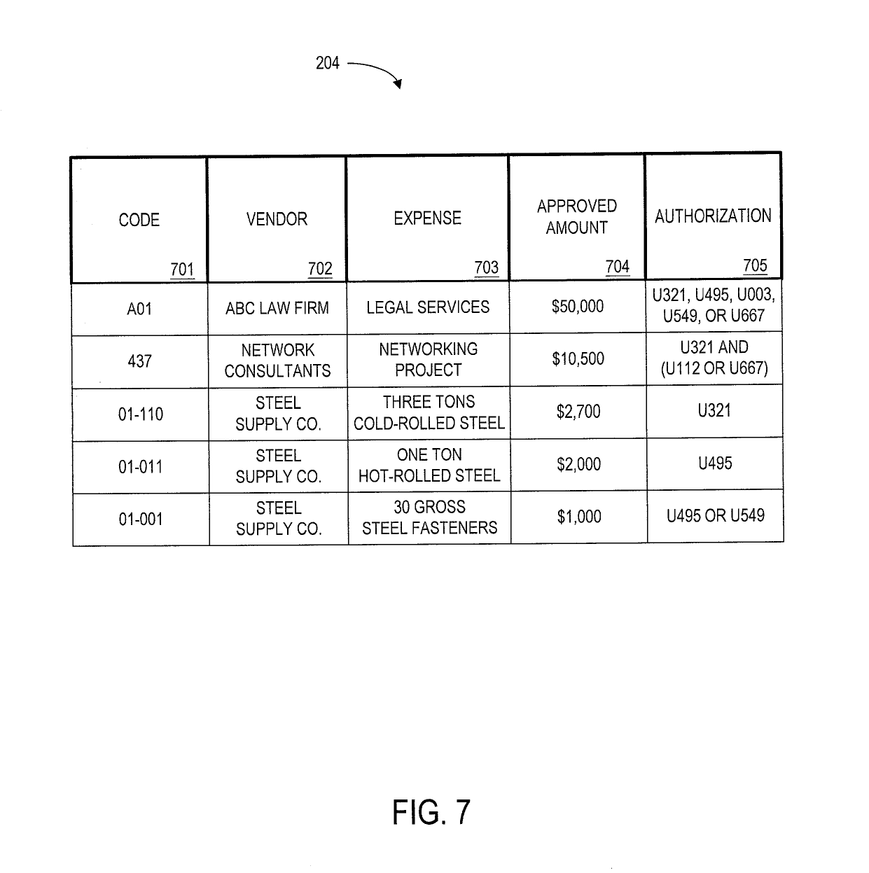

Virtual bank accounts 204 are also stored in data storage device 290 and include one or more virtual bank accounts including associated expenses, users, approved amounts and codes. Of course, virtual bank accounts 204 may include information other than that described above. Virtual bank accounts 204 will be described in more detail with respect to FIG. 7.

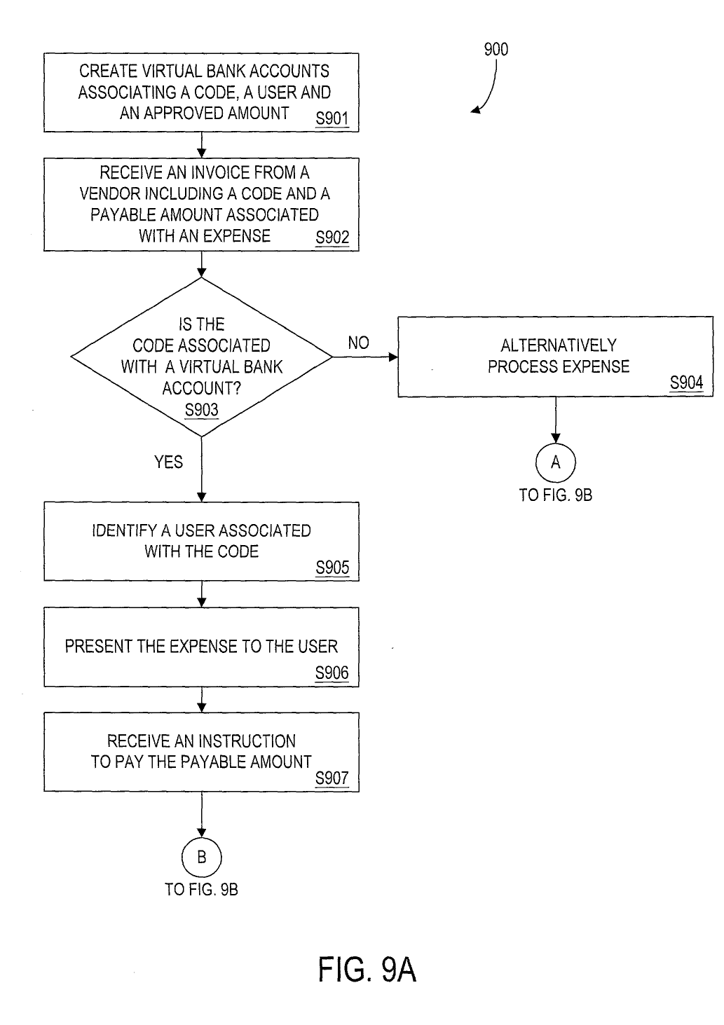

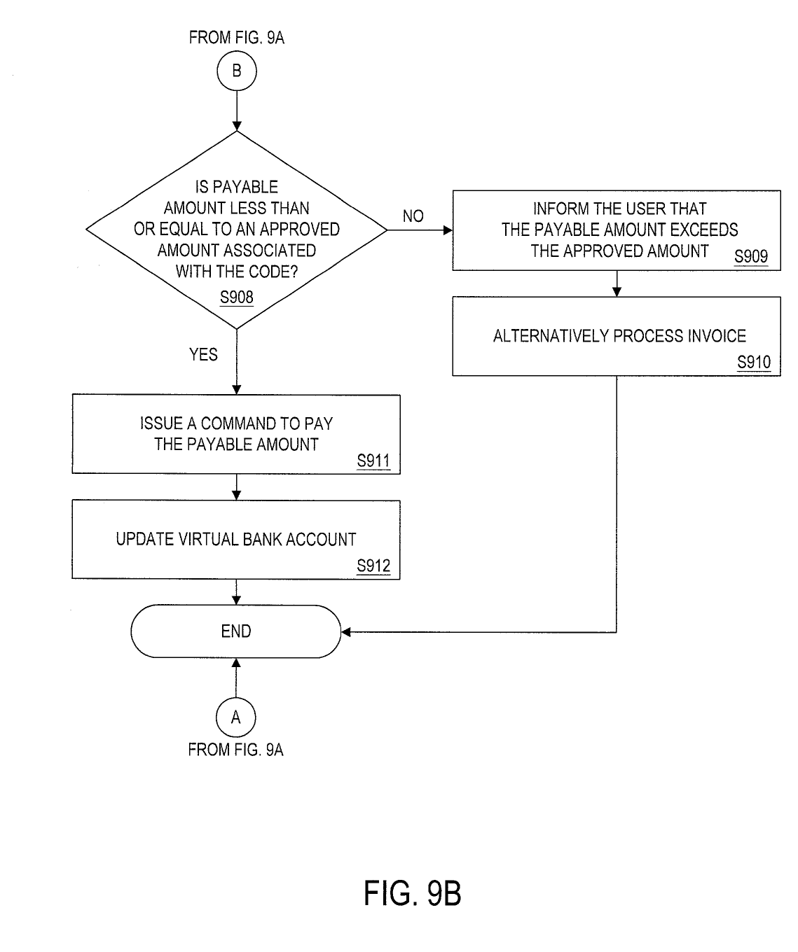

HTML templates 294 are used by Web server 292 to create HTML pages in response to requests received from Web clients. Specifically, client device 400 may transmit a request to payment server 200 for an HTML page representing a specific expense. Accordingly, Web server 292 retrieves an appropriate HTML template from HTML templates 294 and completes the template using invoice data received from vendor device 300 and data from virtual bank accounts 204. A specific example of this process will be described with respect to FIG. 9.

Stored in data storage device 290 may also be other unshown elements that may be necessary for operation of payment server 200, such as other applications, other data files, an operating system, a database management system and “device drivers” for allowing microprocessor 210 to interface with devices in communication with communication port 230. These elements are known to those skilled in the art, and are therefore not described in detail herein.

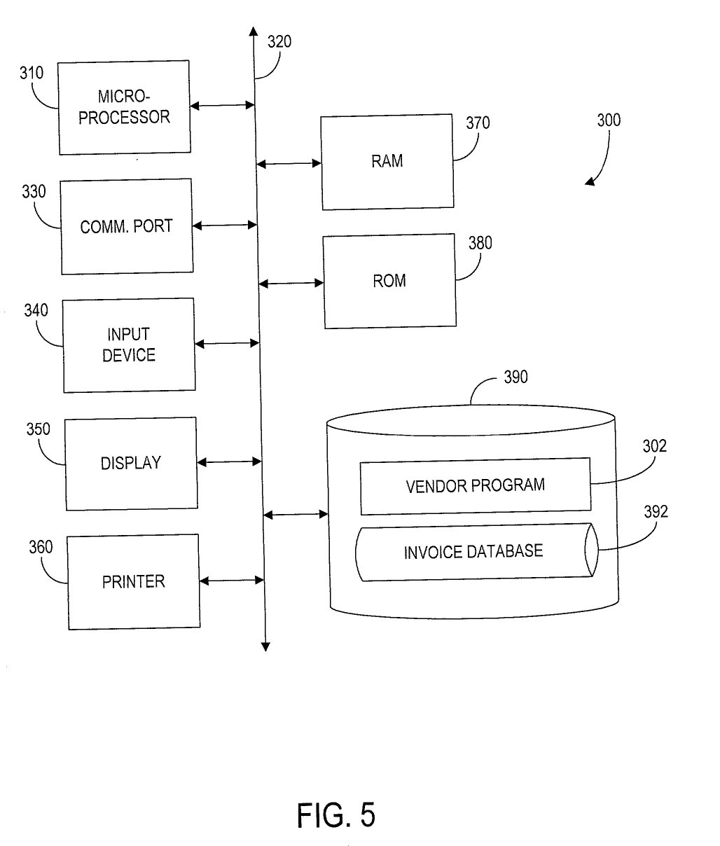

FIG. 5 illustrates several components of vendor device 300 according to one embodiment of the invention. The components may comprise any of the specific examples set forth above with respect to identically-named components of payment server 200. Of course, specific functions performed by the components may differ from the functions performed by the identically-named components.

For example, communication port 330 may be used to receive codes and associated expenses, to transmit invoice data, and to receive payment information. Input device 340 may be used by an operator to input invoice data, commands to transmit invoice data, and commands to print a hardcopy of an invoice using printer 360. Input device 340, display 350 and printer 360 may also be used in conjunction with other applications provided by vendor device 300 which are unrelated to the present invention.

Data storage device 390 stores vendor program 302 of processor-executable process steps. The process steps of vendor program 302 may be executed by microprocessor 310 so as to control vendor device 300 to perform the functions described herein. The process steps of vendor program 302 may be read from a computer-readable medium, such as a floppy disk, a CD-ROM, a DVD-ROM, a Zip™ disk, a magnetic tape, or a signal encoding the process steps, and then stored in data storage device 390 in a compressed, uncompiled and/or encrypted format. In alternative embodiments, hard-wired circuitry may be used in place of, or in combination with, processor-executable process steps for implementation of the processes of the present invention.

Also stored in data storage device 390 is invoice database 392. Invoice database 392 may include information representing invoices created by vendor device 300. Accordingly, the represented invoices may reflect materials and/or services supplied by a vendor operating vendor device 300. The invoices may also reflect amounts owed to other vendors. The information included in invoice database 392 may be transmitted to payment server 200 for payment as described above. Specific types of information that may be stored in invoice database 392 are described below with respect to FIG. 9.

Data storage device 390 may also store application files, data files and system files other than those shown in FIG. 5. These files may be used to provide a vendor with functionality other than that provided by the present invention, such as accounting, inventory and the like.

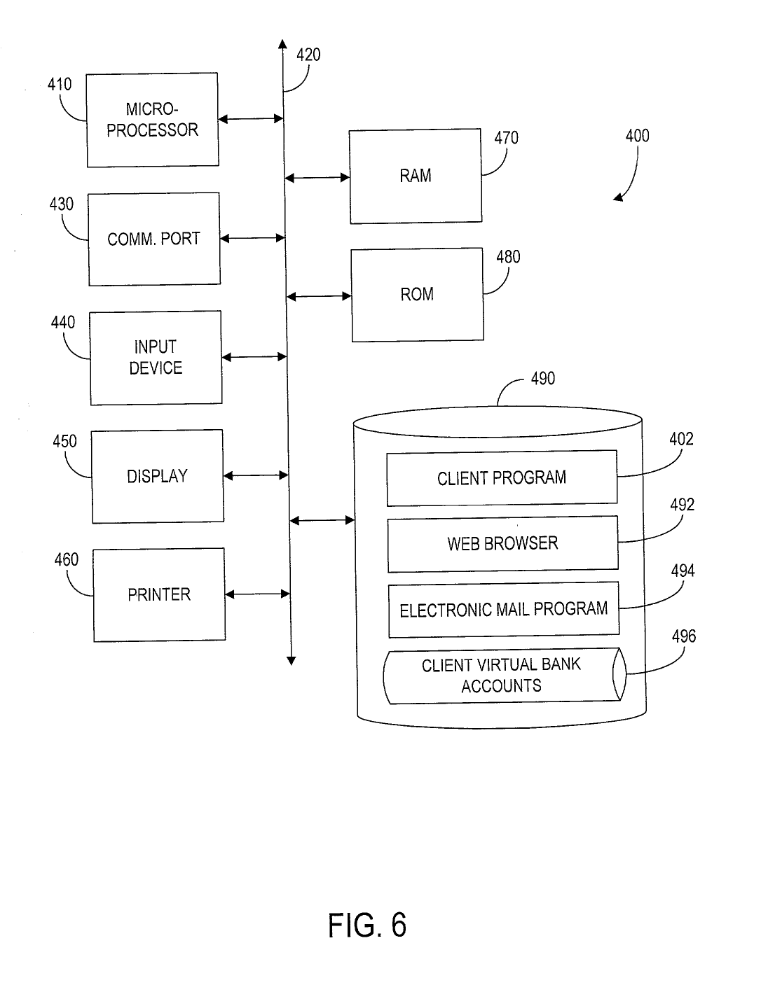

Shown in FIG. 6 is the internal architecture of client device 400 according to one embodiment of the present invention. Again, the components of FIG. 6 may comprise any of the specific examples set forth above with respect to identically-named components of payment server 200 and vendor device 300, but specific functions performed by the components may differ.

In this regard, input device 440 may be used to input user authentication information to obtain access to client device 400, virtual bank account information, a command to pay a payable amount, or any other commands and/or data required to operate an application executed by client device 400. Some or all of this information may also be input via communication port 430. Similarly, display 450 may present an authentication interface, an interface for defining a virtual bank account, an electronic mail message requesting an instruction to pay an expense, an HTML page representing the expense, and any other information contemplated for presentation to the user. Printer 460 may be used to present the information in hardcopy format or to print accounting or other reports.

Data storage device 490 stores processor-executable process steps of client program 402, Web browser 492, and electronic mail program 494. In a case that client device 400 performs the functions represented in FIG. 3, the process steps of client program 402 may be executed by microprocessor 410 to receive an expense, a user, and an approved amount to be associated in a virtual bank account, to transmit the associated information to payment server 200, to receive an expense and a payable amount from payment server 200, to receive an instruction to pay the payable amount, to transmit the instruction to payment server 200, and to receive payment information from payment server 200. According to other embodiments, client program 402 provides client device 400 with less or more of the foregoing functions. The process steps of Web browser 492 may be executed by microprocessor 410 to allow client device 400 to send and receive information over the Web. More specifically, Web browser 492 allows client device 400 to transmit information to and to receive information from a device executing process steps of a Web server, such as payment server 200.

Electronic mail program 494 includes process steps executable to receive and transmit electronic mail. Typically, such process steps include steps to log in to a mail account provided by a mail server, to receive mail from the mail server, to view received mail, to compose mail, and to transmit mail to desired recipients. In the present example, electronic mail program 494 is used to receive and view an electronic mail message indicating receipt of an expense and an associated payable amount.

Also stored in data storage device 490 are client virtual bank accounts 496. Client virtual bank accounts 490 may include information similar to that stored in virtual bank accounts 204. However, in some embodiments, virtual bank accounts 204 reflect virtual bank accounts associated with several client businesses, and client virtual bank accounts 496 reflect virtual bank accounts associated only with the client business operating client device 400.

A tabular representation of a portion of virtual bank accounts 204 is shown in FIG. 7. The portion includes several records, with each record consisting of several associated fields. The fields include code field 701, vendor field 702, expense field 703, approved amount field 704, and authorization field 705. As described above, the information stored in virtual bank accounts 204 may be received from any number of sources, such as from an external device over communication port 230 and from an operator using input device 240. Of course, the information may also be retrieved from removable media having the information stored thereon.

Code field 701 represents a code used to associate information within a virtual bank account. The code may be transmitted to payment server 200 from client device 400 along with other virtual bank account information such as an authorized user and an approved amount. In this case, client device 200 may also transmit the code to vendor device 300 to enable vendor device 300 to associate the code with an appropriate expense when creating an invoice. Alternatively, the code may be created by payment server 200 prior to storing a corresponding record in virtual bank accounts 204. The code may then be transmitted from payment server 200 to vendor device 300 and/or to client device 400.

Vendor field 702 of a virtual bank account record specifies a vendor associated with the virtual bank account. Information stored in vendor field 702 may be received from client device 400 along with other information used to define the virtual bank account. Expense field 703 describes the expense to which a virtual bank account pertains. As described above, expense field 703 may include a broad or a narrow description of expenses such as a description of a particular project, of one or more types of equipment/materials, or of a vendor. For each of the foregoing cases, an associated code stored in code field 701 may simply correspond to a project number, a purchase order number, and a vendor number, respectively.

Approved amount field 704 reflects an amount available in a virtual bank account for applying to an associated expense. A client using client device 400 may specify the amount. In some embodiments, any departments of the client that are required to review and/or routinely approve of payments have done so prior to storage of the amount in approved amount field 704. Such an arrangement facilitates prompt payment because, unlike traditional business-to-business payment systems, payment may be issued once an instruction to pay is received from an authorized user.

Authorized users are specified in authorization field 705. As shown, authorization field 705 may specify one or more authorized users. According to some embodiments, an authorized user is a user to whom an expense and a payable amount are presented, and who may cause payment of the payable amount by issuing an instruction to pay the payable amount. In this regard, a typical authorized user is a manager of a department requesting the expense.

Authorization field 705 may set forth authorization requirements. For example, authorization field 705 may indicate that a payable amount will be paid if any one of several listed users instructs payment, or only if two or more specified users instruct payment. Authorization field 705 may also specify authorization requirements that vary depending on various factors. For example, authorization field 705 may specify that a payable amount of less than $10,000 will be paid if any one of several listed users instructs payment, but that payment of a greater payable amount requires authorization from two users, with one of the two users selected from a subset of the several listed users. Of course, many other types of authorization requirements may be specified according to the present invention.

Although virtual bank accounts 204 show virtual bank accounts of one client, it should be noted that more than one client may be reflected in virtual bank accounts 204 of payment server 200. Such an arrangement is particularly useful in a case that payment server provides invoice paying functionality according to the invention to more than one client business.

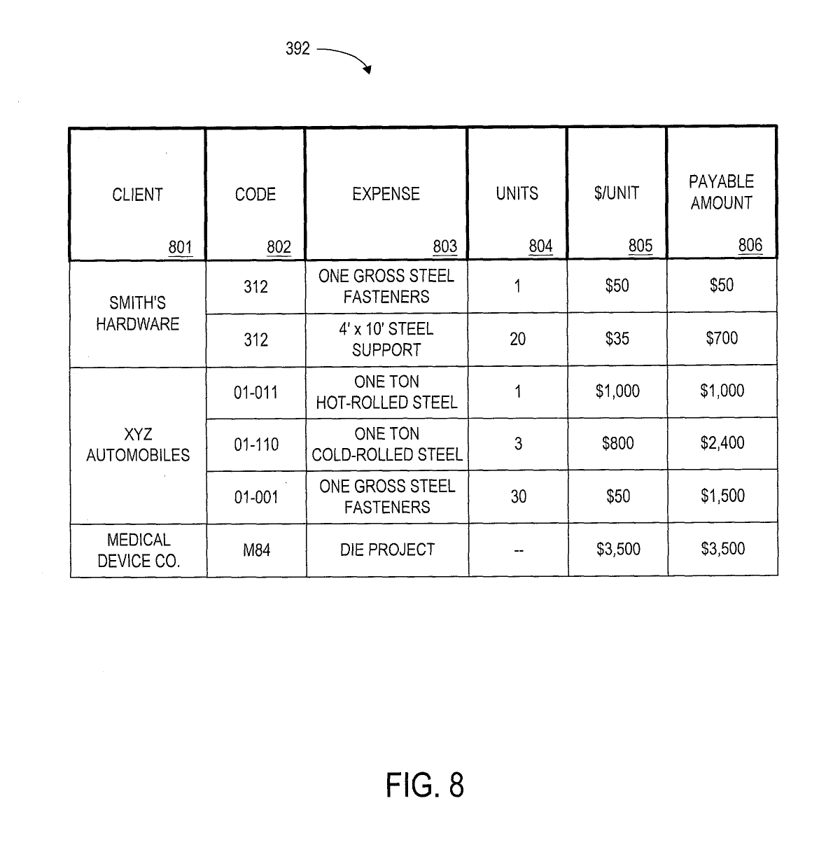

FIG. 8 is a tabular representation of a portion of invoice database 392. As described above, invoice database may be used to record invoices before and/or after the invoices are transmitted to a client for payment. The tabular portion shows several records and associated fields, including client field 801, code field 802, expense field 803, units field 804, $/unit field 805, and payable amount field 806. The information stored in each field may be input by an operator of vendor device 300 using input device 340, or over communication port 330.

Client field 801 specifies a client associated with one or more expenses in invoice database 392. Accordingly, the specified client owes a payment in exchange for the associated expenses. Each expense associated with a client is also associated with a code in code field 802. In some embodiments, the associated code is identical to a code associated with a same expense in code field 701 of virtual bank accounts 204. As described above, the code may be transmitted to vendor device 300 from payment server 200 or from client device 400.

Expense field 803 includes a description of an expense that is associated with a code in code field 802. Although the description may be identical to a description associated with an identical code in expense field 703, it should be noted that these descriptions may differ. In one example, a code in code field 701 is associated with all expenses payable to a specific vendor. Accordingly, a description associated with that code in expense field 703 describes all expenses payable to the specific vendor. However, that same code may be associated with more than one expense in invoice database 392, such as code “312” in code field 802 of FIG. 8.

Units field 804 and $/unit field 805 provide, respectively, a number of units and a price per unit for associated expenses described in expense field 803. This information is useful for creating detailed invoices and for tracking inventory. For expenses that are not quantifiable in units, associated units field 804 is not populated with a number. Payable amount 806 specifies an amount payable in view of entries in associated expense field 803, units field 804 and $/unit field 805.

As will be understood by those skilled in the art, the illustrations and accompanying descriptions of virtual bank accounts 204 and invoice database 392 merely represent relationships between stored information. A number of other arrangements may be employed besides those suggested by the illustrations. Similarly, the illustrated fields and field values represent sample information only; those skilled in the art will understand that the amount and content of this information may be different from that illustrated.

FIGS. 9A and 9B comprise a flow diagram of process steps 900 for paying an invoice according to one embodiment of the present invention. Process steps 900 are described as embodied in payment program 202 and executed by microprocessor 210 of payment server 200. In other embodiments, process steps 900 are embodied, in whole or in part, in a device other than payment server 200 and executed, in whole or in part, by that device or by another device. For example, process steps 900 may be embodied in an application stored in data storage device 490 and executed by microprocessor 410 of client device 400.

In step S901, virtual bank accounts are created, with each virtual bank account including an associated code, user, and approved amount. As described above, a virtual bank account may include other associated information, such as an expense or additional users. For example, virtual bank accounts 204 may be created in step S901 using information received from client device 400.

In a specific example of step S901, an operator uses client device 400 to log in to virtual bank interface 404. Once logged in, the operator inputs a command to create a virtual bank account and also inputs an expense, an authorized user and an approved amount to associate with the virtual bank account. The expense, authorized user and approved amount are transmitted to payment server 200 from virtual bank interface 404 and are associated together with a code to create a virtual bank account.

An invoice including a code, a payable amount and an associated expense is received from a vendor in step S902. The expense may represent materials and/or services provided to a client operating client device 400. In addition, the vendor may have been previously instructed by the client to associate the code with the expense on all transmitted invoices. Of course, the invoice may include several codes associated with expenses and payable amounts. In the present example, the invoice is transmitted from vendor device 300 to payment server 200 in HTML format or as a print stream. As mentioned above, allowing vendor device 300 to transmit a print stream may facilitate incorporation of vendor device 300 into a system embodying the invention.

After the invoice is received, it is determined whether the received code is associated with a virtual bank account. In order to make this determination, payment program 202 may be executed to search virtual bank accounts 204 for a virtual bank account associated with a code identical to that received in step S902. If such a virtual bank account is not identified, flow proceeds to step S904 to alternatively process the expense. Alternative processing may include routing of the invoice to an accounting department for traditional approval and payment. Accordingly, process steps 900 terminate after step S904.

Flow continues to step S905 if it is determined in step S903 that the code is associated with a virtual bank account. In step S905, a user associated with the code is identified. Using virtual bank accounts 204 of “01-110” in step S905. It should be noted that identification of a user in step S905 may include determination of authorization requirements. Specifically, authorization field 705 may be analyzed to identify those users who are needed to instruct payment prior to payment of the received payable amount.

Assuming that one user is identified in step S905, the expense is presented to the one user in step S906. The expense may be presented in any known manner. In one embodiment, an electronic mail message including a hyperlink is transmitted to the user. Accordingly, also stored in payment server 200 may be a data structure associating users with respective electronic mail addresses.

The hyperlink refers to a World Wide Web document provided by Web server 292 executing in payment server 200. Therefore, in response to the user viewing the message and selecting the hyperlink, Web browser 492 executes and transmits a request for the document to Web server 292. Web server receives the request and, using the information received in step S902 and an appropriate template from HTML templates 294, creates the document and transmits the document to Web browser 492.

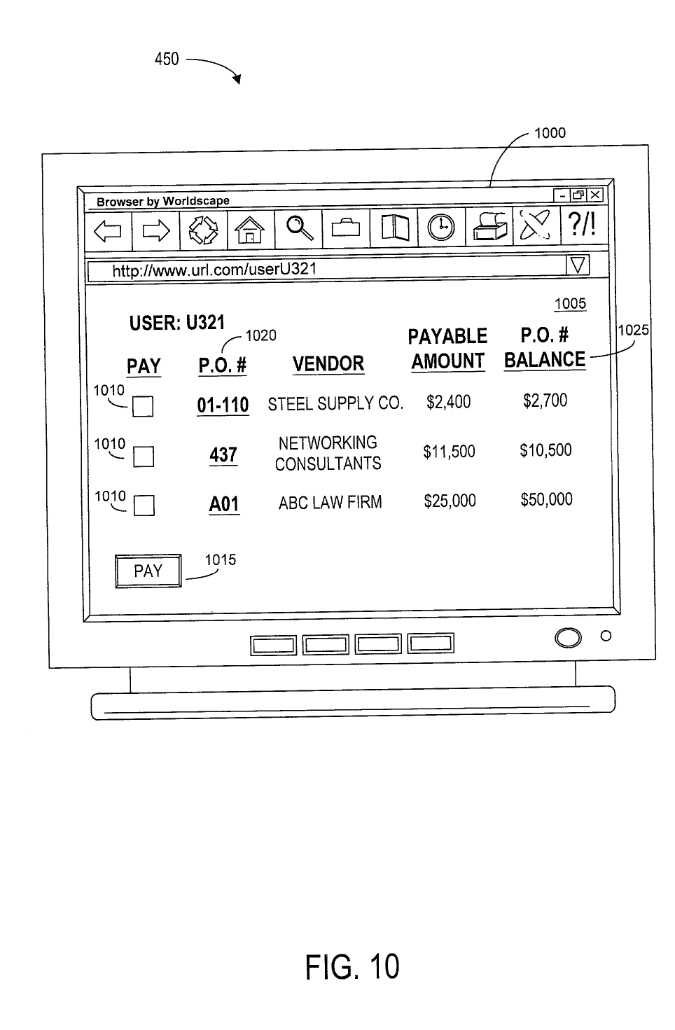

FIG. 10 is a view of display 450 of client device 400 after presentation of an expense according to embodiments of step S906. As shown, user interface 1000 of Web browser 492 displays HTML page 1005. HTML page 1005 includes information received from vendor device 300 as well as other vendor devices. In this regard, payment server 200 has received invoices from several vendors including codes associated with user “U321” in virtual bank accounts 204. Expenses, payable amounts and approved amounts associated with each included code are therefore presented to user “U321” in step S906.

The user may instruct payment of particular payable amounts by selecting corresponding ones of check boxes 1010 and thereafter selecting “Pay” icon 1015. P.O. # column 1020 lists codes corresponding to each listed payable amount. The codes are hyperlinked to allow the user to obtain additional detail about a particular payable amount. Also shown in HTML page 1005 are a vendor and a payable amount associated with each code. In the present example, the vendor is determined by reference to vendor field 702 of virtual bank accounts 204 and the payable amount is identical to the payable amount associated with the code and received from the vendor in step S902. Finally, P.O. balance column 1025 shows values from approved amount field 704 that correspond to the listed codes. These values may be helpful to a user in determining whether to instruct payment of a payable amount. Other information may be presented by HTML page 1005 in association with a code, such as associated information from expense field 703 and/or information from expense field 803 received with the code in step S902.

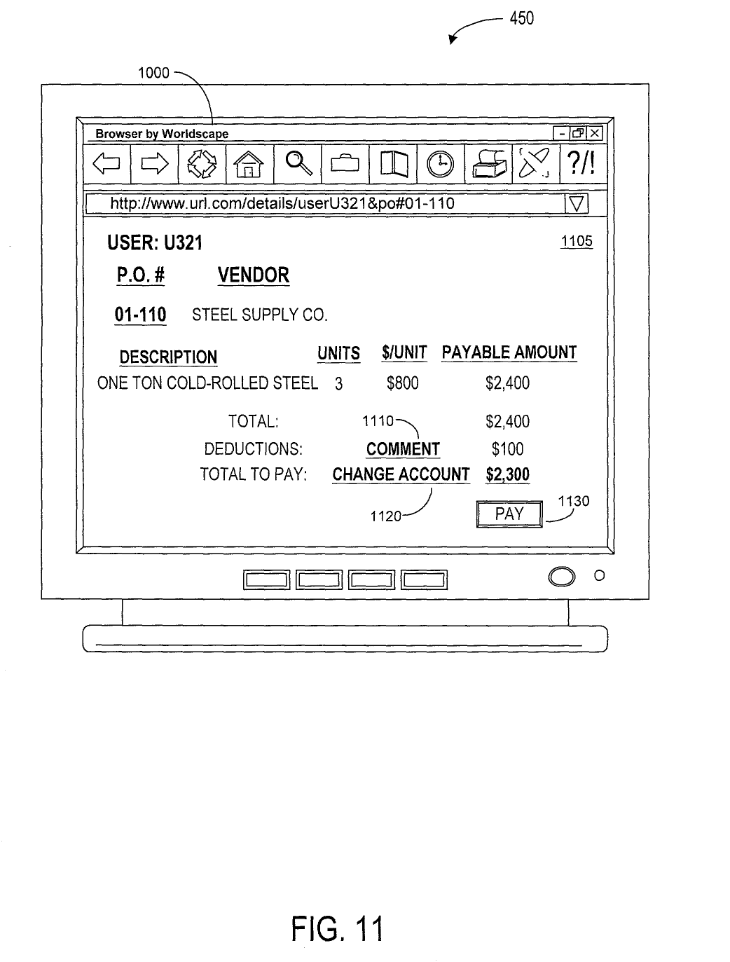

FIG. 11 illustrates another embodiment of step S905. As shown, display 450 presents HTML page 1105 in Web browser window 1000. HTML page 1105 may be created by payment server 200 in response to user selection of a hyperlinked P.O. # of HTML page 1005, or may be presented as an alternative. HTML page 1105 includes details regarding a specific expense such as a description, number of units, and price per unit. This information may be received from vendor device 300 in step S902. Alternatively, the description may be retrieved from associated expense field 703.

HTML page 1105 also includes “Comment” hyperlink 1110 and “Change Account” hyperlink 1120. In some embodiments, a user may select “Comment” hyperlink 1110 to retrieve an HTML page used for entering a deduction to the payable amount and a reason for the deduction. “Change Account” hyperlink 1120 may be used to select different accounting codes or a virtual bank account from which to deduct the payable amount other than the account associated with the displayed P.O. #. Again, “Pay” icon 1130 may be selected to instruct payment of the displayed payable amount.

The instruction to pay the payable amount is received in step S907. As shown in FIG. 3, the instruction may be received from authorization interface 406 by payment server 200. Of course, authorization interface 406 may comprise Web browser 492 and payment server 200 may receive the instruction in the form of an Internet Protocol data packet through Web server 292.

Next, in step S908, it is determined whether the payable amount is less than or equal to an approved amount associated with the code received in step S902. Again, the approved amount may be determined using virtual bank accounts 204. If the determination is negative, flow proceeds to step S909 in which the user is informed that the payable amount exceeds the approved amount.

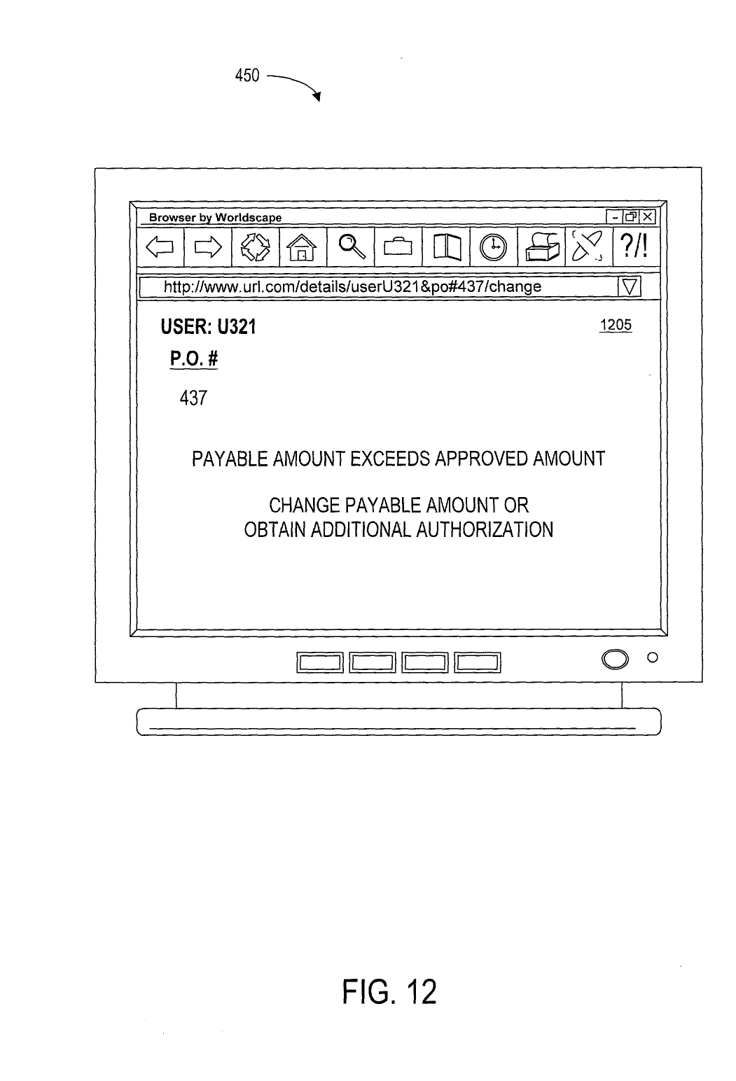

FIG. 12 illustrates display 450 and HTML page 1205 according to one embodiment of step S909. In this example, the user has used HTML page 1005 of FIG. 10 to instruct payment of a payable amount corresponding to code “437”. According to virtual bank accounts 204, the approved amount associated with code “437” is “$10,500”. However, the payable amount received in association with the code in step S902 is “$11,500”. As a result, Web server 292 uses an appropriate template from HTML templates 294 to create HTML page 1205 and transmits HTML page 1205 to the user. Flow then continues to step S910 and proceeds as described with respect to step S904.

Returning to step S908, flow proceeds therefrom to step S911 if it is determined that the payable amount is less than the approved amount. A command to pay the payable amount to the associated vendor is then issued in step S911. The command may be issued by payment program 202 to another software application or device or from one module of payment program 202 to another module of payment program 202. In response to the command, the amount is paid to the vendor using a direct feed to an Automated Clearing House, or another direct or indirect form of payment such as cash or check.

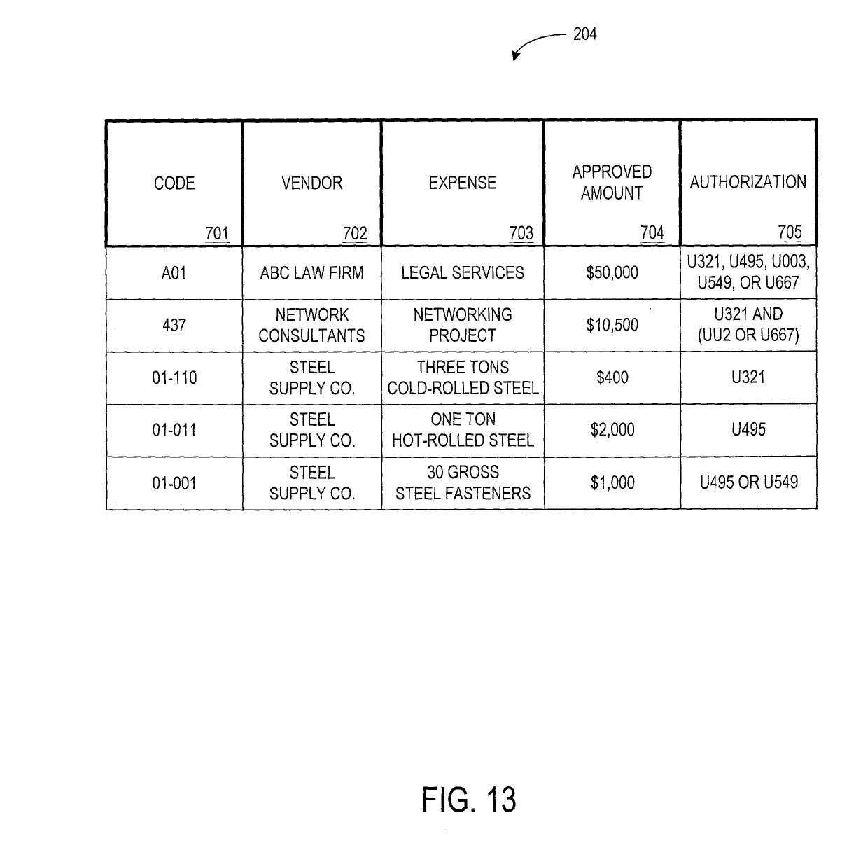

The subject virtual bank account is updated in step S912. FIG. 13 shows virtual bank accounts 204 of FIG. 7 after such an update. As shown, payment server 200 has paid an amount associated with code “01-110” in FIG. 11. Accordingly, associated approved amount field 704 has been updated to reflect the payment. Updating a virtual bank account in step S912 is particularly advantageous in a case of an expense that is expected to generate multiple invoices, such as an ongoing project or an expense reflecting all amounts payable to a vendor.

Process steps 900 terminate after step S912. However, as described above, additional steps may be executed to provide details of the payment to accounts receivable interface 306 and to accounts payable interface 408. Also, process steps 900 may be altered to create embodiments of the invention according to any of the alternative arrangements mentioned herein. Moreover, although the present invention has been described with respect to particular embodiments and alternative arrangements thereof, those skilled in the art will note that various substitutions may be made to those embodiments and arrangements without departing from the spirit and scope of the present invention.

What is claimed is:

1. A method for paying an invoice, comprising:
receiving a code and a payable amount associated with an expense;
identifying a user associated with the code;
presenting the expense to the user;
receiving an instruction to pay the payable amount; and
determining if the payable amount is less than or equal to an approved amount associated with the code.

2. A method according to claim 1, further comprising:
issuing a command to pay the payable amount if it is determined that the payable amount is less than or equal to the approved amount.

3. A method according to claim 2, further comprising:
decrementing the approved amount associated with the code based on the payable amount.

4. A method according to claim 1, wherein the instruction is received from the user.

5. A method according to claim 1, further comprising:
associating an associated approved amount with each of a plurality of codes.

6. A method according to claim 1, wherein the code represents a vendor.

7. A method according to claim 1, wherein the code represents a project.

8. A method according to claim 1, wherein the code represents a purchase order.

9. A method according to claim 1, wherein the identifying step comprises:
analyzing a data structure comprising one or more users associated with each of a plurality of codes.

10. A method according to claim 9, further comprising:
associating one or more users with each of a plurality of expense codes.

11. A method according to claim 1, wherein the instruction is received from the user, wherein the identifying step comprises identifying a second user associated with the code, and further comprising:
receiving a second instruction to pay the payable amount from the second user.

12. A method according to claim 11, further comprising:
issuing a command to pay the payable amount if the first instruction and the second instruction have been received and if it is determined that the payable amount is less than or equal to the approved amount.

13. A method according to claim 12, further comprising:
presenting the expense to the second user.

14. A method according to claim 1, wherein the presenting step comprises:
sending an electronic mail message to the user, the electronic mail message including a selectable link;
receiving an indication that the link has been selected; and
presenting information representing the expense to the user.

15. A method for paying an invoice, comprising:
receiving a code and a payable amount associated with an expense;
determining if the payable amount is less than or equal to an approved amount associated with the code; and
presenting the expense to a user associated with the code if it is determined that the payable amount is less than or equal to the approved amount.

16. A method according to claim 15, wherein the expense is not presented to the user if it is determined that the payable amount is not less than or equal to the approved amount.

17. A method according to claim 15, further comprising:
transmitting an indication to the user if it is determined that the payable amount is not less than or equal to the approved amount, the indication indicating that the payable amount is not less than or equal to the approved amount.

18. A method for paying an invoice, comprising:
receiving a code and a payable amount associated with an expense;
determining if the payable amount is less than or equal to an approved amount associated with the code; and
transmitting an indication to a user associated with the code if it is determined that the payable amount is not less than or equal to the approved amount, the indication indicating that the payable amount is not less than or equal to the approved amount.

19. A method according to claim 18, further comprising:
presenting the expense to the user.

20. A method according to claim 18, further comprising:
receiving an instruction to pay the payable amount.

21. A method according to claim 18, wherein the determining step comprises:
analyzing a data structure comprising one or more users associated with each of a plurality of codes.

22. A method according to claim 21, further comprising:
associating one or more users with each of a plurality of expense codes.

23. A method for paying an invoice, comprising:
receiving a code and a payable amount associated with an expense;
identifying a user associated with the code;
identifying an approved amount associated with the code; and
presenting the expense, the payable amount, and the approved amount to the user.

24. A method according to claim 23, further comprising:
receiving an instruction to pay the payable amount.

25. A method according to claim 24, further comprising:
issuing a command to pay the payable amount if it is determined that the payable amount is less than or equal to the approved amount.

26. A method according to claim 25, further comprising:
decrementing the approved amount associated with the code based on the payable amount.

27. A method according to claim 23, wherein the determining step comprises:
analyzing a data structure comprising one or more users associated with each of a plurality of codes.

28. A method according to claim 27, further comprising:
associating one or more users with each of a plurality of expense codes.

29. A method for paying an invoice, comprising:
receiving a code and a payable amount associated with an expense;
identifying a user associated with the code;
transmitting the expense to a client device after the user accesses the client device;
receiving an instruction to pay the payable amount;
determining if the payable amount is less than or equal to an approved amount associated with the code;
issuing a command to pay the payable amount if it is determined that the payable amount is less than or equal to the approved amount; and decrementing the approved amount based on the payable amount.

30. A medium storing processor-executable process steps to pay an invoice, the process steps comprising:
a step to receive a code and a payable amount associated with an expense;
a step to identify a user associated with the code;
a step to present the expense to the user;
a step to receive an instruction to pay the payable amount; and
a step to determine if the payable amount is less than or equal to an approved amount associated with the code.

31. A medium according to claim 30, the process steps further comprising:
a step to issue a command to pay the payable amount if it is determined that the payable amount is less than or equal to the approved amount.

32. A medium according to claim 31, the process steps further comprising:
a step to decrement the approved amount associated with the code based on the payable amount.

33. A medium according to claim 30, wherein the instruction is received from the user.

34. A medium according to claim 30, the process steps further comprising:
a step to associate an associated approved amount with each of a plurality of codes.

35. A medium according to claim 30, wherein the code represents a vendor.

36. A medium according to claim 30, wherein the code represents a project.

37. A medium according to claim 30, wherein the code represents a purchase order.

38. A medium according to claim 30, wherein the identifying step comprises:
a step to analyze a data structure comprising one or more users associated with each of a plurality of codes.

39. A medium according to claim 38, the process steps further comprising:
a step to associate one or more users with each of a plurality of expense codes.

40. A medium according to claim 30, wherein the instruction is received from the user, wherein the identifying step comprises a step to identify a second user associated with the code, and the process steps further comprising:
a step to receive a second instruction to pay the payable amount from the second user.

41. A medium according to claim 40, the process steps further comprising:
a step to issue a command to pay the payable amount if the first instruction and the second instruction have been received and if it is determined that the payable amount is less than or equal to the approved amount.

42. A medium according to claim 41, the process steps further comprising:
a step to present the expense to the second user.

43. A medium according to claim 30, wherein the presenting step comprises:
a step to send an electronic mail message to the user, the electronic mail message including a selectable link;
a step to receive an indication that the link has been selected; and
a step to present information representing the expense to the user.

44. A medium storing processor-executable steps to pay an invoice, the process steps comprising:
a step to receive a code and a payable amount associated with an expense;
a step to determine if the payable amount is less than or equal to an approved amount associated with the code; and
a step to present the expense to a user associated with the code if it is determined that the payable amount is less than or equal to the approved amount.

45. A medium according to claim 44, wherein the expense is not presented to the user if it is determined that the payable amount is not less than or equal to the approved amount.

46. A medium according to claim 44, the process steps further comprising:
a step to transmit an indication to the user if it is determined that the payable amount is not less than or equal to the approved amount, the indication indicating that the payable amount is not less than or equal to the approved amount.

47. A medium storing processor-executable steps to pay an invoice, the process steps comprising:
a step to receive a code and a payable amount associated with an expense;
a step to determine if the payable amount is less than or equal to an approved amount associated with the code; and
a step to transmit an indication to a user associated with the code if it is determined that the payable amount is not less than or equal to the approved amount, the indication indicating that the payable amount is not less than or equal to the approved amount.

48. A medium according to claim 47, the process steps further comprising:
a step to present the expense to the user.

49. A medium according to claim 47, the process steps further comprising:
a step to receive an instruction to pay the payable amount.

50. A medium according to claim 47, wherein the determining step comprises:
a step to analyze a data structure comprising one or more users associated with each of a plurality of codes.

51. A medium according to claim 50, the process steps further comprising:
a step to associate one or more users with each of a plurality of expense codes.

52. A medium storing processor-executable process steps to pay an invoice, the proces steps comprising:
a step to receive a code and a payable amount associated with an expense;
a step to identify a user associated with the code;
a step to identify an approved amount associated with the code; and
a step to present the expense, the payable amount, and the approved amount to the user.

53. A medium according to claim 52, the process steps further comprising:
a step to receive an instruction to pay the payable amount.

54. A medium according to claim 53, the process steps further comprising:
a step to issue a command to pay the payable amount if it is determined that the payable amount is less than or equal to the approved amount.

55. A medium according to claim 54, the process steps further comprising:
a step to decrement the approved amount associated with the code based on the payable amount.

56. A medium according to claim 52, wherein the determining step comprises:
a step to analyze a data structure comprising one or more users associated with each of a plurality of codes.

57. A medium according to claim 56, the process steps further comprising:
a step to associate one or more users with each of a plurality of expense codes.

58. A medium storing processor-executable process steps to pay an invoice, the process steps comprising:
a step to receive a code and a payable amount associated with an expense;
a step to identify a user associated with the code;
a step to transmit the expense to a client device after the user accesses the client device;
a step to receive an instruction to pay the payable amount;
a step to determine if the payable amount is less than or equal to an approved amount associated with the code;
a step to issue a command to pay the payable amount if it is determined that the payable amount is less than or equal to the approved amount; and
a step to decrement the approved amount based on the payable amount.

59. An apparatus for paying an invoice, comprising:
a storage device storing processor-executable process steps and a data structure associating each of a plurality of codes with a user and an approved amount; and
a processor in communication with the storage device,
wherein the processor-executable process steps are adapted to be executed by said processor to:
receive a code and a payable amount associated with an expense;
identify a user associated with the code;
present the expense to the user;
receive an instruction to pay the payable amount; and
determine if the payable amount is less than or equal to an approved amount associated with the code.

60. An apparatus for paying an invoice, comprising:
a storage device storing processor-executable process steps and a data structure associating each of a plurality of codes with a user and an approved amount; and
a processor in communication with the storage device,
wherein the processor-executable process steps are adapted to be executed by said processor to:
receive a code and a payable amount associated with an expense;
identify a user associated with the code;
transmit the expense to a client device after the user accesses the client device;
receive an instruction to pay the payable amount;
determine if the payable amount is less than or equal to an approved amount associated with the code;
issue a command to pay the payable amount if it is determined that the payable amount is less than or equal to the approved amount; and
decrement the approved amount based on the payable amount.

61. A system for paying an invoice, comprising:
a payment system storing a data structure associating each of a plurality of codes with a user and an approved amount; and
a client device,
wherein the payment system receives a code and a payable amount associated with an expense, identifies a user associated with the code, transmits the expense to the client device after the user accesses the client device, receives an instruction to pay the payable amount, and determines if the payable amount is less than or equal to an approved amount associated with the code, and
wherein the client device receives a request from the user to access the client device, provides the user with access to the client device, presents the expense to the user, receives an indication from the user to pay the payable amount, and transmits the instruction to pay the payable amount to the payment system.

62. A system according to claim 61, wherein the payment system issues a command to pay the payable amount if it is determined that the payable amount is less than or equal to the approved amount.

63. A system according to claim 62, wherein, after issuing the command, the payment system decrements the approved amount associated with the code based on the payable amount.

64. A system according to claim 61, wherein the payment system sends an electronic mail message including a selectable link to the user, the client device receives the message, the client device presents the message to the user, the client device receives an indication that the link has been selected, and the client device transmits a second indication to the payment system that the link has been selected.
